(19) United States
(12) Patent Application Publication
(10) Pub. No.: US 2024/0395029 A1
(43) Pub. Date: Nov. 28, 2024

(54) CONTROL DEVICE CAPABLE OF SUPPRESSING LOWERING OF ACCURACY OF INFERENCE RESULT, METHOD OF CONTROLLING CONTROL DEVICE, LEARNING METHOD OF NEURAL NETWORK, AND STORAGE MEDIUM

(71) Applicant: CANON KABUSHIKI KAISHA, Tokyo (JP)

(72) Inventors: Dai MIYAUCHI, Chiba (JP); Hiroshi KANEKO, Kanagawa (JP)

(21) Appl. No.: 18/665,694

(22) Filed: May 16, 2024

(30) Foreign Application Priority Data
May 24, 2023 (JP) 2023-085463

(51) Int. Cl. G06V 10/82; G06V 10/75; G06V 10/77; G06V 10/776; G10L 25/60

(52) U.S. Cl. CPC G06V 10/82; G06V 10/751; G06V 10/7715; G06V 10/776; G10L 25/60

(57) ABSTRACT

A control device performs inference processing using data items related to each other as inputs. A first inference model is formed by layers using data items as inputs, for feature value extraction, and a connection layer outputting output data as an inference result based on the extracted feature values, and a second inference model to which data is input, for feature value extraction. If all data items are usable, the controller controls the second inference model not to extract feature values, and the first inference model to output the output data from the connection layer based on extracted feature values. If data is unusable, the controller controls the first inference model to output the output data from the connection layer based on feature values extracted by layers using usable input data, and feature value(s) extracted by the second inference model using the usable input data.

### BACKGROUND OF THE INVENTION

### Field of the Invention

The present invention relates to a control device that is capable of suppressing lowering of the accuracy of an inference result, a method of controlling the control device, a learning method of a neural network, and a storage medium.

### Description of the Related Art

A deep learning technique using a neural network is used in a wide range of fields, and particularly, it is said that classification by the deep learning technique for classifying images by recognizing the images has exceeded the human recognition ability. Particularly, a convolutional neural network (CNN), which is widely used, realizes high-accuracy deep learning by recursive convolution of images. In recent years, an inference model obtained by such deep learning has been used for expression recognition processing for recognizing a facial expression included in a captured image. The expression recognition processing using the inference model improves the accuracy of recognizing an expression mainly from information of irregularities, texture, outline, and so forth of a face, which are extracted from an image, but the improvement of the accuracy is not high enough because the expression is recognized based only on single modal information, such as a captured image.

On the other hand, there has been proposed a technique of performing deep learning using a plurality of modal information items. Japanese Laid-Open Patent Publication (Kokai) No. 2022-2023 proposes a related art. According to Japanese Laid-Open Patent Publication (Kokai) No. 2022-2023, a plurality of inference models are caused to perform consolidate learning using a plurality of modal information items, whereby it is possible to improve the accuracy of an inference result, compared with a case where learning is performed using single modal information.

However, even when the above-described technique disclosed in Japanese Laid-Open Patent Publication (Kokai) No. 2022-2023 is used, in a case where any of the plurality of modal information items is defective modal information, the accuracy of an inference result obtained with respect to the defective modal information is lowered, and hence even when a plurality of inference models are caused to perform consolidate learning, the accuracy of the inference result based on the plurality of modal information items is lowered.

### SUMMARY OF THE INVENTION

The present invention provides a control device that is capable of suppressing lowering of the accuracy of an inference result, a method of controlling the control device, a learning method of a neural network, and a storage medium.

In a first aspect of the present invention, there is provided a control device that performs inference processing using a plurality of data items related to each other as inputs, including a first inference model that is formed by a plurality of layers to which the plurality of data items are input, respectively, for extraction of feature values of input data items, and a connection layer which outputs output data as an inference result based on the extracted feature values, a second inference model to which any of the plurality of data items are input for extraction of a feature value of each of the any input data item, a control unit configured to control operations of the first inference model and the second inference model, and a determination unit configured to determine whether or not each of the plurality of data items is usable for the inference processing, wherein the control unit controls, in a case where it is determined by the determination unit that all of the plurality of data items are usable for the inference processing, the second inference model not to perform extraction of feature values, and the first inference model to output the output data from the connection layer based on a plurality of feature values extracted by the plurality of layers, and controls, in a case where it is determined by the determination unit that any of the plurality of data items is unusable for the inference processing, the first inference model to output the output data from the connection layer, based on a feature value extracted by each layer to which data determined by the determination unit to be usable for the inference processing is input, and a feature value extracted by the second inference model using the data determined by the determination unit to be usable for the inference processing as an input.

In a second aspect of the present invention, there is provided a method of controlling a control device that performs inference processing using a plurality of data items related to each other as inputs, including controlling an operation of a first inference model that is formed by a plurality of layers to which the plurality of data items are input, respectively, for extraction of feature values of input data items, and a connection layer which outputs output data as an inference result based on the extracted feature values, and an operation of a second inference model using any of the plurality of data items as an input for extraction of a feature value of the input data item, and determining whether or not each of the plurality of data items is usable for the inference processing, said controlling includes controlling, in a case where it is determined by said determining that all of the plurality of data items are usable for the inference processing, the second inference model not to perform extraction of feature values, and the first inference model to output the output data from the connection layer based on a plurality of feature values extracted by the plurality of layers, and controlling, in a case where it is determined by said determining that any of the plurality of data items is unusable for the inference processing, the first inference model to output the output data from the connection layer, based on a feature value extracted by each layer to which data determined by the determination unit to be usable for the inference processing is input, and a feature value extracted by the second inference model using the data determined by said determining to be usable for the inference processing as an input.

According to the present invention, it is possible to suppress lowering of the accuracy of an inference result.

Further features of the present invention will become apparent from the following description of exemplary embodiments (with reference to the attached drawings).

### BRIEF DESCRIPTION OF THE DRAWINGS

FIG. 1 is a block diagram showing a configuration of a control device according to an embodiment of the present invention.

FIG. 2 is a block diagram showing a configuration of a neural network section appearing in FIG. 1.

FIGS. 3A to 3C are diagrams each showing an example of image data used by the control device shown in FIG. 1.

FIGS. 4A to 4C are diagrams each showing an example of sound data used by the control device shown in FIG. 1.

FIGS. 5A to 5C are diagrams each showing an example of sound data used by the control device shown in FIG. 1.

FIG. 6 is a flowchart of an area-of-interest estimation process performed by the control device shown in FIG. 1.

FIGS. 7A to 7C are diagrams showing a method of learning parameters used for the neural network section appearing in FIG. 1.

FIGS. 8A and 8B are diagrams each showing an example of image data used by the control device shown in FIG. 1.

FIG. 9 is a block diagram showing a configuration of a control device according to a variation of the present embodiment, which uses three associated input data items as inputs.

FIG. 10 is a diagram showing a configuration of a neural network section appearing in FIG. 9.

FIGS. 11A to 11D are diagrams each showing an example of image data generated through continuous image capturing.

FIG. 12 is a flowchart of an image quality improvement process performed by the control device shown in FIG. 9.

### DESCRIPTION OF THE EMBODIMENTS

The present invention will now be described in detail below with reference to the accompanying drawings showing embodiments thereof.

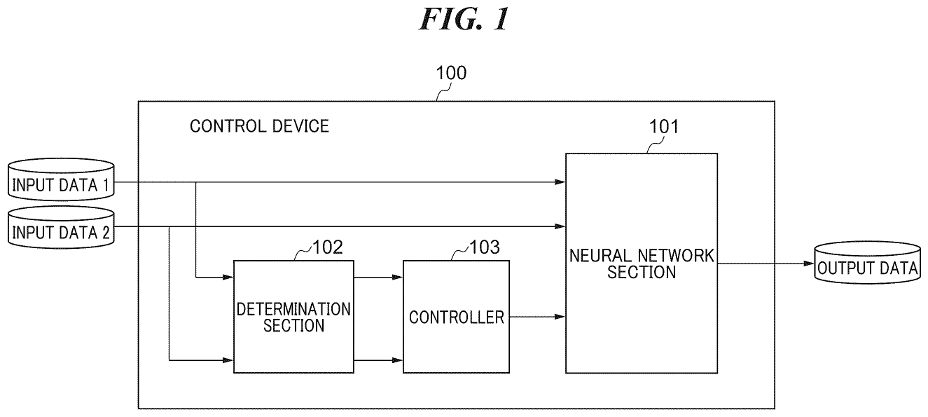

FIG. 1 is a block diagram showing a configuration of a control device 100 according to an embodiment of the present invention. The control device 100 performs consolidate inference processing based on two associated input data items to output an inference result. In the present embodiment, a description will be given of a configuration that, based on image data input as input data 1 and sound data input as input data 2, the control device 100 performs inference processing for inferring an area of interest in the input image data. Note that the area of interest is an area of the image data where attention is paid to a person who is speaking.

Referring to FIG. 1, the control device 100 includes a neural network section 101, a determination section 102, and a controller 103. The neural network section 101 uses image data and sound data as inputs, performs inference processing for inferring an area of interest according to an instruction from the controller 103, and outputs an inference result as output data. An output destination of the output data is, for example, an internal storage (not shown) included in the control device 100 or an external apparatus which can communicate with the control device 100 via a communication network, such as the Internet. In the present embodiment, the neural network section 101 is a processor that is capable of performing product-sum operation and nonlinear processing which are employed by a general neural network model. The determination section 102 determines whether or not image data and sound data, which have been input, can be used for inference processing for inferring an area of interest and transmits a determination result to the controller 103. Note that a method of the determination will be described hereinafter. The controller 103 transmits an instruction for controlling the inference processing for inferring an area of interest to the neural network section 101 based on the determination result acquired from the determination section 102.

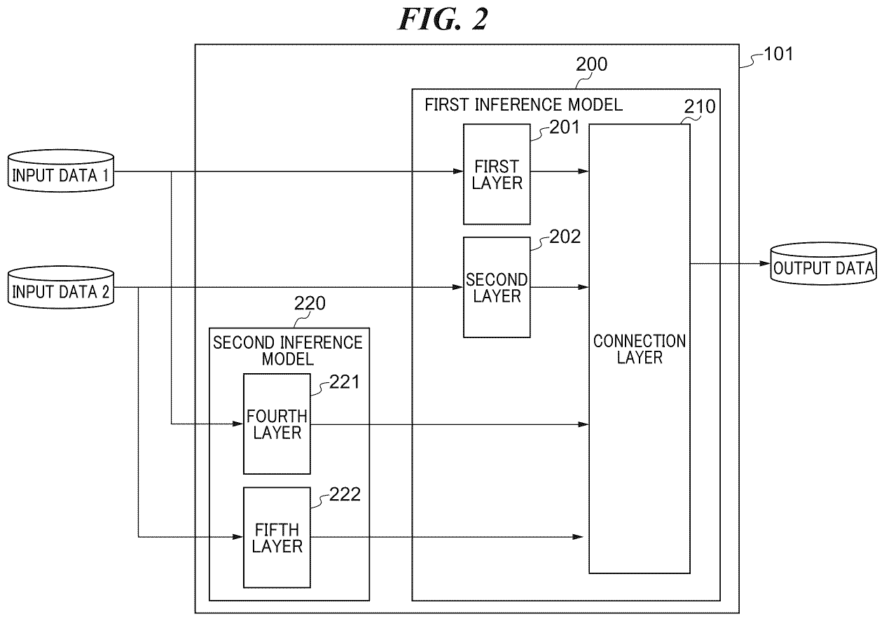

FIG. 2 is a block diagram showing a configuration of the neural network section 101 appearing in FIG. 1. Note that in the present embodiment, the neural network section 101 is implemented by a convolutional neural network (CNN). Although in general, bias addition, nonlinear processing, and so on are included in the CNN processing, detailed description thereof is omitted in the present embodiment. However, the present invention does not limit the configuration of the neural network section 101 only to the CNN, but an operation, such as fully connection processing, can be included.

Referring to FIG. 2, the neural network section 101 is formed by a first inference model 200 and a second inference model 220.

The first inference model 200 is formed by a first layer 201, a second layer 202, and a connection layer 210.

The first layer 201 uses image data as an input and extracts a feature value of a person of interest from the image data. As the feature value of a person of interest, the first layer 201 extracts a likelihood to be the person of interest, for example, based on the three feature points of a right eye, a left eye, and a nose.

The second layer 202 uses sound data as an input and extracts a feature value of the person of interest from the sound data. For example, as the feature value of a person of interest, the second layer 202 extracts a likelihood to be the person of interest, for example, based on the feature point of a pitch of sound.

The second inference model 220 is a model learned in advance so as to prevent the accuracy of an inference result from being lowered even without using input data determined to be unusable by the determination section 102, and is formed by a fourth layer 221 and a fifth layer 222.

Similar to the first layer 201, the fourth layer 221 uses image data as an input and extracts a feature value of the person of interest from the image data. As the feature value of a person of interest, the fourth layer 221 extracts a likelihood to be the person of interest based on a feature point different from those of the first layer 201, for example, based on the feature point of a mouth. Thus, in the present embodiment, the fourth layer 221 extracts a likelihood to be the person of interest based on the feature point different from those of the first layer 201.

Similar to the second layer 202, the fifth layer 222 uses sound data as an input and extracts a feature value of the person of interest from the sound data. As the feature value of a person of interest, the fifth layer 222 extracts a likelihood to be the person of interest based on a feature point different from that for the second layer 202, for example, based on the feature point of a volume of sound. Thus, in the present embodiment, the fifth layer 222 extracts a likelihood to be the person of interest based on the feature point different from that for the second layer 202.

The connection layer 210 performs inference processing by combining feature values extracted by two of the first layer 201, the second layer 202, the fourth layer 221, and the fifth layer 222, determined by the determination section 102 based on a result of determination on the usability of input data. The connection layer 210 outputs a result of the inference processing (inference result) as output data. Note that an operation for extracting a feature value is not performed by the layers other than the above-mentioned two of the first layer 201, the second layer 202, the fourth layer 221, and the fifth layer 222. Therefore, as an output from each layer which does not perform the operation, a predetermined fixed value is input to the connection layer 210 in place of a feature value.

Next, the determination on the usability of input data, which is performed by the determination section 102, will be described. First, the determination on the usability of image data as input data will be described.

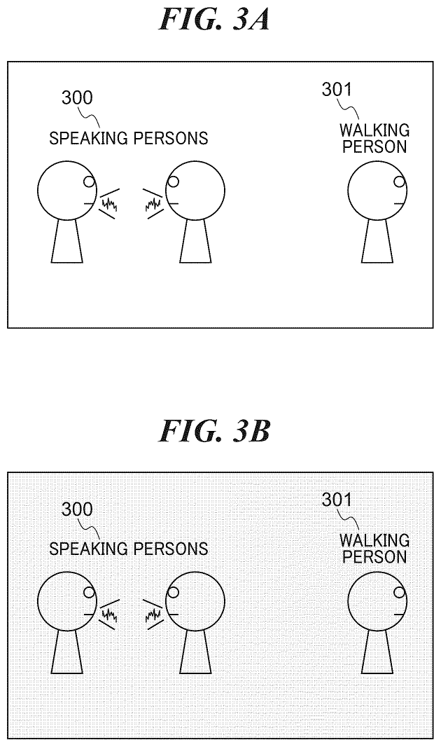

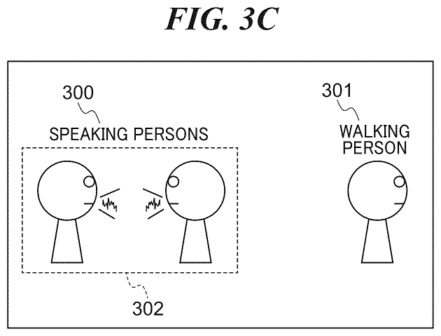

FIGS. 3A to 3C are diagrams each showing an example of image data used by the control device 100 shown in FIG. 1.

The image data shown in FIG. 3A and the image data shown in FIG. 3B each include speaking persons 300 and a walking person 301. Note that the image data shown in FIG. 3B is image data which is lower in luminance than the image data shown in FIG. 3A.

The determination section 102 calculates an evaluation value of the input image data. For example, the determination section 102 calculates an average value of the luminance as the evaluation value of the input image data. In a case where the calculated average value of the luminance is higher than a luminance threshold value which is predetermined, the determination section 102 determines that the input image data can be used. For example, the determination section 10 determines that the image data shown in FIG. 3A, in which the calculated luminance average value is higher than the luminance threshold value, is usable. Note that in the present embodiment, the luminance threshold value is set to a value of a luminance level at which a feature of a person can be extracted by the first layer 201.

On the other hand, in a case where the calculated average value of the luminance is not higher than the luminance threshold value, the determination section 102 determines that the input image data cannot be used. For example, the determination section 102 determines that the image data shown in FIG. 3B, in which the calculated luminance average value is not higher than the luminance threshold value, is unusable. Note that in the present embodiment, a description is given of the configuration that the usability of the image data is determined based on an average value of the luminance of input image data, by way of example, but the present invention is not limited to this configuration. For example, the usability of the image data can be determined based on an S/N ratio of the luminance of input image data. Further, the usability of the image data can be determined based on parameters of image data, which can be compared with predetermined threshold values, such as a blur amount and an amount of high-sensitivity noise in input image data. Further, the usability of this image data can be determined based on results of comparison of these parameters in input image data with respective threshold values associated thereof.

Next, the determination on the usability of sound data as the input data will be described.

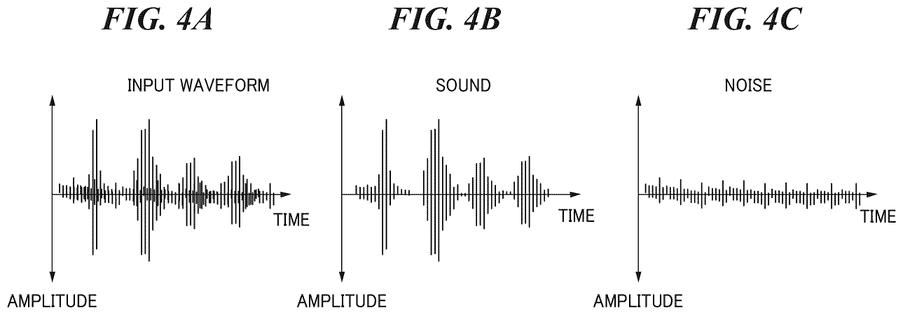

FIGS. 4A to 4C are diagrams each showing an example of sound data used by the control device 100 shown in FIG. 1. FIG. 4A shows an example of a waveform of the sound data input to the control device 100. The sound data includes a voice component (feature component) of the speaking persons 300 and an environment sound component (noise component) generated around the speaking persons 300.

In the present embodiment, for example, when the sound data shown in FIG. 4A is input, the determination section 102 separates the sound data into a waveform shown in FIG. 4B and a waveform shown in FIG. 4C. The waveform shown in FIG. 4B is obtained by separating the voice component of the speaking persons 300 from the waveform shown in FIG. 4A. The waveform FIG. shown in 4C is obtained by separating the noise component other than the voice component (feature component) from the waveform shown in FIG. 4A. In the present embodiment, the waveform shown in FIG. 4C is used as an evaluation value of the input sound data.

Then, in a case where the maximum amplitude of the noise component shown in FIG. 4C is equal to or smaller than a noise threshold value which is predetermined, determined in advance, the determination section 102 determines that the sound data shown in FIG. 4A is usable. Note that as the noise threshold value, for example, the maximum value of amplitude in the voice component of the speaking persons 300, shown in FIG. 4B, is set.

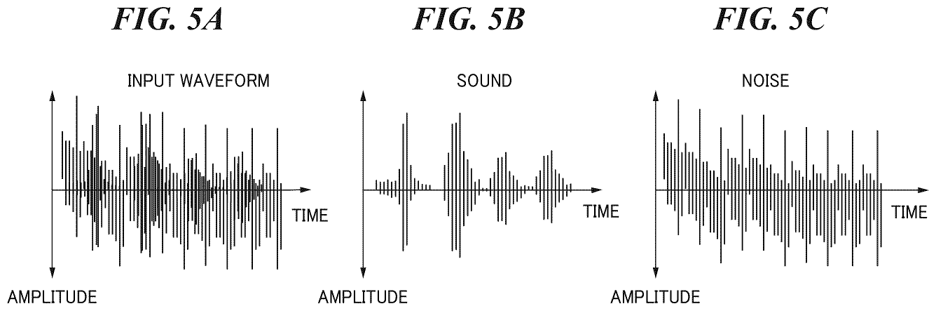

FIGS. 5A to 5C are also diagrams each showing an example of sound data used by the control device 100 shown in FIG. 1. FIG. 5A shows an example of a waveform of sound data which is larger in noise component than the sound data shown in FIG. 4A.

For example, when the sound data shown in FIG. 5A is input, the determination section 102 separates this sound data into a waveform shown in FIG. 5B and a waveform shown in FIG. 5C. The waveform shown in FIG. 5B is obtained by separating the voice component of the speaking persons 300 from the waveform shown in FIG. 5A. Note that the voice component in the sound data shown in FIG. 5A corresponds to the voice component in the sound data shown in FIG. 4A, and the waveform shown in FIG. 5B corresponds to the waveform shown in FIG. 4B. The waveform shown in FIG. 5C is obtained by separating the noise component other than the voice component from the waveform shown in FIG. 5A, and the nose component is large than that of the waveform shown in FIG. 4C. The waveform shown in FIG. 5C is also used for an evaluation value of the input sound data.

In a case where the maximum amplitude of the noise component shown in FIG. 5C is larger than the noise threshold value which is predetermined, the determination section 102 determines that the sound data shown in FIG. 5A is unusable. Note that although in the present embodiment, the description has been given of the configuration that the usability of this sound data is determined based on the noise component of input sound data, the present invention is not limited to this configuration. For example, the usability of this sound data can be determined based on parameters of sound data, which can be compared with respective predetermined threshold values, such as a volume of input sound data.

It is possible to recognize a person from image data only by the first layer 201 which uses the image data as an input, but it is difficult to identify whether the person is one of the speaking persons 300 or the walking person 301. To cope with this, the present embodiment is configured such that the one of the speaking persons 300 can be identified by performing consolidate inference processing by the second layer 202 using sound data as an input and the first layer 201 using image data as an input.

On the other hand, in a case where the input sound data is improper data which is determined by the determination section 102 as unusable for inference processing, if the inference processing is performed using the sound data, there is a fear that the accuracy of the inference result is lowered. For this reason, it is preferable to perform the inference processing without using the sound data. However, if the inference processing is performed only by the first layer 201 without using the sound data, as mentioned above, it is impossible to accurately identify whether the person recognized from image data is one of the speaking persons 300 or the walking person 301.

To solve this problem, in the present embodiment, in a case where one of the input image data and sound data is determined by the determination section 102 as unusable for the inference processing, the following process is performed: Output data is output from the connection layer 210 based on a feature value extracted from one of the first layer 201 and the second layer 202, which uses data determined to be usable for the inference processing, as an input, and a feature value extracted by the second inference model 220 using the data determined to be usable as an input.

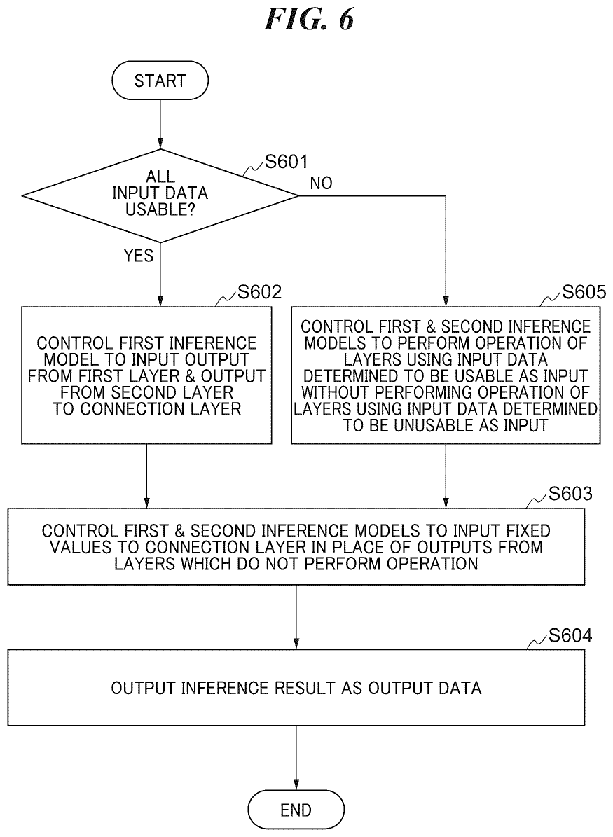

FIG. 6 is a flowchart of an area-of-interest inference process performed by the control device 100 shown in FIG. 1. The area-of-interest inference process in FIG. 6 is executed when the control device 100 acquires image data and sound data as input data.

Referring to FIG. 6, first, in a step S601, the determination section 102 determines whether or not all of acquired input data items can be used for inference processing. Specifically, the determination section 102 calculates an evaluation value of each acquired input data item, compares the calculated evaluation value and a predetermined threshold value, and determines whether or not each input data can be used for inference processing. For example, as described above, the determination section 102 calculates an average value of the luminance of the image data as the input data and compares the calculated luminance average value and the luminance threshold value. Further, as described above, the determination section 102 extracts a noise component of the sound data as the input data and compares the maximum amplitude of the extracted noise component and the noise threshold value. For example, in a case where the image data shown in FIG. 3A, in which the average value of the luminance is higher than the luminance threshold value, and the sound data shown in FIG. 4A, in which the maximum amplitude of the noise component is not higher than the noise threshold value, are input, it is determined in the step S601 that all of the acquired input data items are usable. In this case, the area-of-interest inference process proceeds to a step S602.

In the step S602, the controller 103 controls the first inference model 200 to input an output from the first layer 201 and an output from the second layer 202 to the connection layer 210. Further, the controller 103 controls the second inference model 220 such that neither the fourth layer 221 nor the fifth layer 222 performs an operation. Thus, in the present embodiment, in a case where it is determined that the acquired image data and sound data are both usable, the controller 103 controls the second inference model 220 not to extract feature values. Further, the controller 103 controls the first inference model 200 to output the output data from the connection layer 210 based on a plurality of feature values extracted by the first layer 201 and the second layer 202.

Then, in a step S603, the controller 103 controls the first inference model 200 and the second inference model 220 such that predetermined fixed values are input to the connection layer 210 in place of outputs from layers which do not perform respective operations. Specifically, the controller 103 controls the second inference model 220 to input the fixed value associated with the fourth layer 221 and the fixed value associated with the fifth layer 222 to the connection layer 210 in place of outputs from the fourth layer 221 and the fifth layer 222 which do not perform respective operations. Note that the predetermined fixed values are values used when the learning of the first inference model 200 and the second inference model 220 was performed. With this control, the neural network section 101 formed by the first inference model 200 and the second inference model 220 can determine that the reference processing to be performed thereby is processing in which the second inference model 220 does not perform an operation. As a result, it is possible to output an inference result with higher accuracy than in a case where data which is not associated with the learning is input to the connection layer 210.

Then, in a step S604, the neural network section 101 performs the operation of the neural network according to the control of the controller 103 and outputs an inference result as output data. After that, the area-of-interest inference process is terminated. Thus, in the present embodiment, it is possible to identify an area where attention is paid to the speaking persons 300, such as indicated by an area 302 in FIG. 3C, as the area of interest.

On the other hand, if it is determined in the step S601 that one of the acquired input data items is unusable, the area-of-interest inference process proceeds to a S605. For example, in a case where the image data shown in FIG. 3B, in which the average value of the luminance is not higher than the luminance threshold value, is input, or a case where the sound data shown in FIG. 5A, in which the maximum amplitude of the noise component is higher than the noise threshold value, is input, it is determined in the step S601 that one of the acquired input data items is unusable. Note that in the present embodiment, in a case where image data in which the average value of the luminance is not higher than the luminance threshold value and sound data in which the maximum amplitude of the noise component is higher than the noise threshold value, are input, the following determination is performed: One of these input data items, which is the smaller in difference between the evaluation value and the threshold value, is determined to be usable, and the other which is the larger in difference between the evaluation value and the threshold value, is determined to be unusable.

In the S605, the controller 103 controls the first inference model 200 and the second inference model 220 such that a layer to which the input data determined to be usable is input performs an operation but a layer to which the input data determined to be unusable is input does not perform an operation.

For example, if it is determined by the determination section 102 that the image data is usable and the sound data is unusable, it means that the image data is proper data and the sound data is improper data. In this case, the controller 103 controls the first inference model 200 and the second inference model 220 such that the second layer 202 and the fifth layer 222 to which the sound data determined to be unusable is input do not perform respective operations. Further, the controller 103 controls the first inference model 200 and the second inference model 220 such that the first layer 201 and the fourth layer 221 to which the image data determined to be usable is input perform respective operations. With this control, it is possible to increase the resources used for the image data which is the proper data, by an amount of the resources to be used by the second inference model 220. Further, in the second inference model 220, a feature value of the person of interest is extracted based on a feature point different from that for the first layer 201 of the first inference model 200, and hence it is possible to suppress lowering of the accuracy of an inference result on the area of interest based on the feature value, even without using the sound data which is the improper data.

Further, if it is determined by the determination section 102 that the image data is unusable and the sound data is usable, it means that the image data is improper data and the sound data is proper data. In this case, the controller 103 controls the first inference model 200 and the second inference model 220 such that the first layer 201 and the fourth layer 221 to which the image data determined to be unusable is input do not to perform respective operations. Further, the controller 103 controls the first inference model 200 and the second inference model 220 such that the second layer 202 and the fifth layer 222 to which the sound data determined to be usable is input perform respective operations. With this control, it is possible to increase the resources used for the sound data which is the proper data by an amount of the resources to be used by the second inference model 220. Further, in the second inference model 220, a feature value of the person of interest is extracted based on a feature point different from that for the second layer 202 of the first inference model 200, and hence it is possible to suppress lowering of the accuracy of an inference result on the area of interest based on the feature value even without using the image data which is the improper data.

Then, the area-of-interest inference process proceeds to the step S603. For example, if it is determined by the determination section 102 that the image data is usable and the sound data is unusable, the controller 103 controls, in the step S603, the first inference model 200 and the second inference model 220 as follows: The controller 103 performs control to input the fixed value associated with the second layer 202 and the fixed value associated with the fifth layer 222 to the connection layer 210, in place of the outputs from the second layer 202 and the fifth layer 222 which do not perform respective operations. Further, if it is determined by the determination section 102 that the image data is unusable and the sound data is usable, in the step S603, the controller 103 controls the first inference model 200 and the second inference model 220 as follows: The controller 103 performs control to input the fixed value associated with the first layer 201 and the fixed value associated with the fourth layer 221 to the connection layer 210 in place of the outputs from the first layer 201 and the fourth layer 221 which do not perform respective operations. Note that these fixed values are also values used when the learning of the first inference model 200 and the second inference model 220 was performed. With this control, the neural network section 101 formed by the first inference model 200 and the second inference model 220 can determine the inference processing to be performed thereby is processing in which only one of the image data and the sound data is used. As a result, it is possible to output an inference result with higher accuracy than in a case where data which is not associated with learning is input to the connection layer 210. Then, the area-of-interest inference process proceeds to the step S604.

According to the above-described embodiment, in a case where it is determined by the determination section 102 that one of input data items is unusable for inference processing, the following processing is performed: Output data is output from the connection layer 210 based on a feature value extracted by one of the first layer 201 and the second layer 202, to which data determined to be usable for the inference processing is input, and a feature value extracted by the second inference model 220 using the data as an input. With this, it is possible to perform the inference processing using not only the feature value extracted by the one of the first layer 201 and the second layer 202, to which the data determined to be usable for the inference processing is input, but also the feature value extracted by the second inference model 220 based on a feature point different from that for the above-mentioned layer. This makes it possible to suppress lowering of the accuracy of an inference result.

Further, in the above-described embodiment, an evaluation value is calculated with respect to each input data item, and whether or not the data can be used for inference processing is determined based on a result of comparison between the calculated evaluation value and the threshold value. With this, it is possible to suppress lowering of the accuracy of an inference result even when one of the input data items is unusable for the inference processing.

Further, in the above-described embodiment, since the input data items are image data and sound data, in the inference processing using image data and sound data as inputs, it is possible to suppress lowering of the accuracy of an inference result.

In the above-described embodiment, the evaluation value is a value related to one of the luminance of image data, a blur amount of image data, and an amount of high-sensitivity noise of image data. With this, even when improper image data degraded due to the luminance, the blur amount, or the amount of high-sensitivity noise is input, it is possible to suppress lowering of the accuracy of an inference result.

In the above-described embodiment, the evaluation value is a value related to an amount of noise with respect to the feature component of sound data is used for determination whether the sound data is usable or not, and hence even when improper sound data degraded due to noise is input to the control device 100, it is possible to suppress lowering of the accuracy of an inference result.

Next, learning of parameters used for the neural network section 101 will be described.

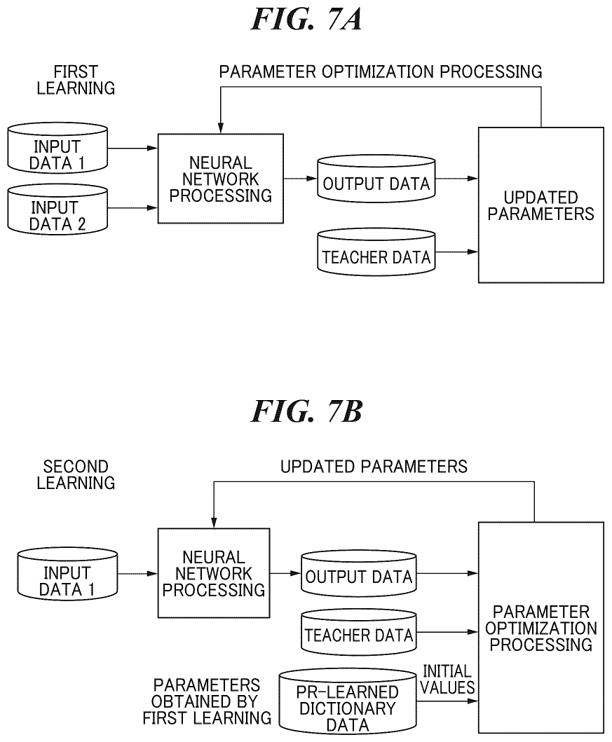

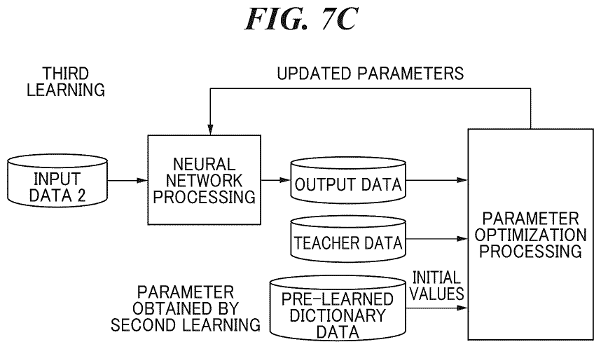

FIGS. 7A to 7C are diagrams showing a method of learning parameters used for the neural network section 101 appearing in FIG. 1. Note that in the present embodiment, the parameters used for the neural network section 101 are learned by another device, such a personal computer (PC), in advance. In the present embodiment, the learning is performed three separate times while changing the configuration of the neural network section 101.

FIG. 7A is a diagram useful in explaining the first learning.

In the neural network processing in FIG. 7A, the learning is performed using a model configuration in which, with the configuration shown in FIG. 2, control is performed such that the first layer 201 and the second layer 202 perform respective operations but the fourth layer 221 and the fifth layer 222 perform respective operations, and in place of the outputs from the fourth layer 221 and the fifth layer 222, predetermined fixed values are input to the connection layer 210. In the present embodiment, the predetermined fixed value is set to a value of 0 which has the same data length as the data length of the input data input to the connection layer 210. Note that although in the present embodiment, the same values is set to the value of 0 by way of example but it is not limited to the value of 0. In the present embodiment, the same value as the fixed value used when learning was performed, for example, a value of 0, is used as the fixed value in the step S603. By using the same value as the fixed value used in the learning for the inference as the fixed value in the step S603, the neural network section 101 can determine that the inference processing to be performed thereby is processing in which the second inference model 220 does not perform an operation.

In the first learning (first learning), a plurality of image data items and a plurality of sound data items are used as the input data. Note that the image data and the sound data are data related to each other. Note that as the learning data in the first learning, only proper data, such as data determined to be usable by the determination section 102, is used. By using only proper data, it is possible to properly perform learning adapted to a case where proper image data and proper sound data are input. The first learning is performed with the described model configuration and learning data.

The first learning is performed by acquiring updated parameters, which have been processed by parameter optimization processing such that the output data as a result of the operation performed by the neural network processing and the teacher data become close to each other, and updating dictionary data of the neural network.

The updated parameter obtained when the first learning is completed is used for the second learning as pre-learned dictionary data. Note that the teacher data is only required to be prepared by generating data of an area of interest, which is generated in advance using image data and sound data as inputs, and the same teacher data can be used in the first, second, and third learning operations. Further, data generated by using the pre-learned dictionary data can be set as the teacher data. Further, values of the pre-learned dictionary data can be set to initial values and be used for the second learning.

Next, the second learning will be described. FIG. 7B is a diagram useful in explaining the second learning.

In the neural network processing shown in FIG. 7B, the learning is performed using a model configuration in which, with the configuration shown in FIG. 2, control is performed such that the first layer 201 and the fourth layer 221 perform respective operations but the second layer 202 and the fifth layer 222 do not perform respective operations, and in place of the outputs from the second layer 202 and the fifth layer 222, predetermined fixed values are input to the connection layer 210.

In the second learning, as the input data, a plurality of image data items are used. Note that as the second learning data, only proper data, such as data determined to be usable by the determination section 102, is used. The second learning is performed using the described model configuration and learning data. Note that the second learning is performed by the same method as employed in the first learning. The updated parameters obtained when the second learning is completed are used for the third learning as pre-learned dictionary data.

Next, the third learning will be described. FIG. 7C is a diagram useful in explaining the third learning.

In the neural network processing shown in FIG. 7C, the learning is performed using a model configuration in which, with the configuration shown in FIG. 2, control is performed such that the second layer 202 and the fifth layer 222 perform respective operations but the first layer 201 and the fourth layer 221 do not perform respective operations, and in place of the outputs from the first layer 201 and the fourth layer 221, predetermined fixed values are input to the connection layer 210.

In the third learning, as the input data, a plurality of sound data items are used. Note that in the third learning, only proper data, such as data determined to be usable by the determination section 102, is used. The third learning is performed with the described model configuration and learning data. Note that the third learning is performed by the same method as employed in the first learning.

Note that although in the present embodiment, the description has been given of the configuration in which the two types of input data are used, learning can be performed by a model configuration in which more than three types of data items are input and three or more processing layers associated with these data items, respectively, perform respective operations, and learning can be further performed a plurality of times.

The above is the outline of the learning. Note that the learning algorithm of the neural network, including backpropagation, is a category of a known technique, and hence description thereof is omitted in the present embodiment.

As described above, in the present embodiment, it is possible to obtain the first inference model 200 and the second inference model 220, which are used for the above-described area-of-interest inference process in FIG. 6, whereby it is possible to suppress lowering of the accuracy of an inference result.

Note that in the present embodiment, the neural network section 101 can be configured to use a plurality of image data items as inputs, which are obtained by capturing the image of a person as an object at different angles, and perform inference processing for identifying the person whose image is captured in these image data items. With this, in the inference processing using a plurality of image data items as inputs, which are captured at different angles, for identifying a specific person whose image is captured in these image data items, it is possible to suppress lowering of the accuracy of an inference result.

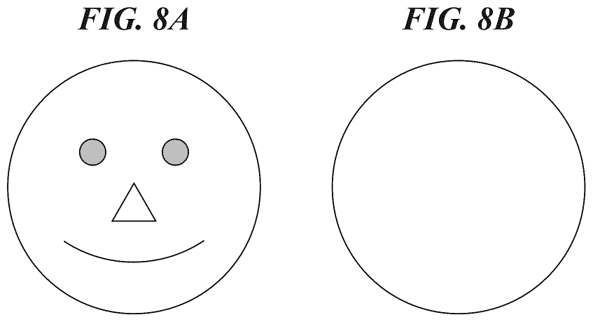

With such a configuration, the neural network section 101 uses two image data items captured at different angles as inputs and outputs information on a specific person whose image is captured in these image data items as output data. For example, the neural network section 101 uses image data shown in FIG. 8A, which is obtained by capturing the image of an object from the front, and image data shown in FIG. 8B, which is obtained by capturing the image of the object from the back, as inputs, and outputs information on a specific person from these image data items, as output data. Note that the information on the specific person can be data of an image format or data of a text format insofar as it is information enabling identification of a person.

In this configuration, the determination section 102 determines the usability of input data based on whether or not the input data is in a state in which it is possible to determine a person appearing in the image data as a specific person. In the present embodiment, based on an orientation of a human face, whether or not the input data is in a state in which a person appearing in the image data can be determined as a specific person. For example, as shown in FIG. 8A, the image data obtained by capturing the image of the object from the front includes information enabling identification of a person, such as eyes, a nose, and a mouth, and hence the determination section 102 determines that this image data is usable. On the other hand, as shown in FIG. 8B, the image data obtained by capturing the image of the object from the back does not include information enabling identification of a person, such as eyes, a nose, or a mouth, and hence the determination section 102 determines that this image data is unusable.

Thus, since the determination section 102 determines the usability of input data based on the orientation of a human face, in the inference processing for identifying a specific person appearing in two input image data items, even when one of these two image data items is such image data, shown in FIG. 8B, which includes no information enabling identification of a person, it is possible to suppress lowering of the accuracy of an inference result.

Further, in the present embodiment, the determination section 102 can determine the usability of image data as input data, based on image-capturing conditions of the image data. The image-capturing conditions are information at the time of capturing image data, such as an image-capturing device name, a resolution, a shutter speed, an aperture (F-value), an ISO sensitivity, a photometry mode, use/unuse of a flash, an exposure correction step value, and a focal length. For example, in a case where the ISO value of image data largely exceeds a normal ISO of a camera used for capturing the image data, there is a fear that the accuracy of an inference result is degraded depending on the degree of degradation of image quality. To cope with this, in a case where the ISO value of image data largely exceeds the normal ISO, the determination section 102 determines that the image data is unusable. With this, it is possible to prevent the accuracy of an inference result from being lowered due to the image-capturing conditions of input image data.

Further, in the present embodiment, the control device can use three or more associated input data items as inputs. The following description will be given of the configuration in which the control device uses three associated input data items as inputs by way of example.

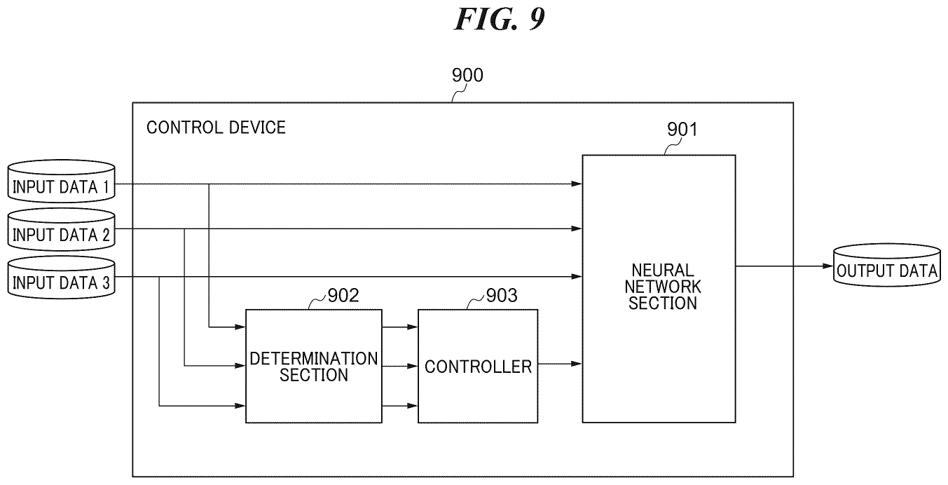

FIG. 9 is a block diagram showing a configuration of a control device 900 according to a variation of the present embodiment, which uses three associated input data items as inputs. The control device 900 performs consolidate inference processing based on three associated input data items and outputs an inference result.

Referring to FIG. 9, the control device 900 includes a neural network section 901, a determination section 902, and a controller 903. The neural network section 901 uses three time-series image data items as inputs, performs inference processing, more specifically, an image quality improvement process, described hereinafter, according to an instruction from the controller 903, and outputs image data subjected to the image quality improvement process as output data. Note that a destination of outputting the output data is, for example, an internal storage (not shown) included in the control device 900 or an external apparatus which can communicate with the control device 900 via a communication network, such as the Internet. Similar to the above-described neural network section 101, the neural network section 901 is a processor that is capable of performing product-sum operation and nonlinear processing which are employed by a general neural network model. The determination section 902 determines whether or not input image data can be used for inference processing and transmits a determination result to the controller 903. Note that the determination method will be described hereinafter. The controller 903 transmits an instruction for controlling the image quality improvement process to the neural network section 901 based on a determination result acquired from the determination section 902.

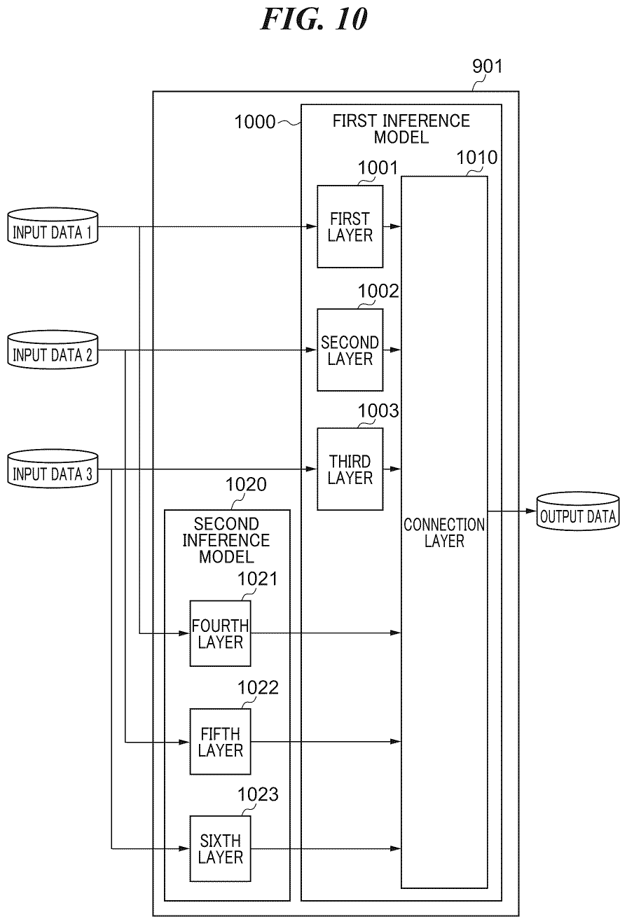

FIG. 10 is a diagram showing a configuration of the neural network section 901 appearing in FIG. 9. The neural network section 901 uses three time-series image data items, specifically, image data of interest and image data items of frames before and after the image data of interest as inputs, and performs the image quality improvement process according to an instruction from the controller 903. In the image quality improvement process, noise reduction is performed for eliminating noise from the image data of interest, using the image data items of frames before and after the image data of interest as reference image data. Thus, by performing noise reduction using a plurality of image data items, it is possible to improve the accuracy of detecting edges and noise portions from image data and realize noise reduction with high accuracy. Note that in the present embodiment, image data of a frame before image data of interest is input as input data 1, the image data of interest is input as input data 2, and image data of a frame after the image data of interest is input as input data 3.

Referring to FIG. 10, the neural network section 901 is formed by a first inference model 1000 and a second inference model 1020.

The first inference model 1000 is formed by a first layer 1001 using the input data 1 as an input, a second layer 1002 using the input data 2 as an input, a third layer 1003 using the input data 3 as an input, and a connection layer 1010.

The first layer 1001, the second layer 1002, and the third layer 1003 each are a neural network layer for performing noise reduction and each extract a feature value of input image data. For example, as the feature value of image data, information indicating a high-frequency edge, information indicating a spatially specific pixel, or the like is extracted.

The second inference model 1020 is a model which has performed learning in advance so as to prevent the accuracy of an inference result from being lowered even without using input data determined to be unusable by the determination section 902. The second inference model 1020 is formed by a fourth layer 1021 using the input data 1 as an input, a fifth layer 1022 using the input data 2 as an input, and a sixth layer 1023 using the input data 3 as an input. The fourth layer 1021, the fifth layer 1022, and the sixth layer 1023 each extract a feature value from a feature point different from that for the first layer 1001, the second layer 1002, and the third layer 1003. For example, the fourth layer 1021, the fifth layer 1022, and the sixth layer 1023 each extract information on a human skin area as the feature value of input image data. Note that if the first layer 1001, the second layer 1002, and the third layer 1003 perform processing operations including those of the fourth layer 1021, the fifth layer 1022, and the sixth layer 1023, respectively, the processing time increases. For this reason, in the present embodiment, the configuration is such that the first layer 1001, the second layer 1002, and the third layer 1003 perform processing very high in influence on the image quality.

Note that in the present embodiment, the operation resources used by the fourth layer 1021, the fifth layer 1022, and the sixth layer 1023 can be changed, and the controller 903 determines these operation resources based on a result of determination performed by the determination section 902 on the usability of input data.

The connection layer 1010 outputs output data based on outputs from ones of the first layer 1001, the second layer 1002, the third layer 1003, the fourth layer 1021, the fifth layer 1022, and the sixth layer 1023, to which data determined to be usable by the determination section 902 is input. For example, the connection layer 1010 identifies noise portions in the image data of interest based on feature values acquired from the layers using input data determined to be usable by the determination section 902 as inputs and performs noise reduction by performing averaging processing on the identified noise portions. Further, the connection layer 1010 causes edges in the image data of interest to be preserved, based on information on edges as the acquired feature values. Thus, image data which has been subjected to the image quality improvement process and from which noise has been eliminated, is output as output data.

Next, the determination performed by the determination section 902 on the usability of input data will be described. The determination section 902 calculates a difference in luminance between the input image data of interest and the reference image data and determines the usability of the input image data based on a result of comparison between the calculated luminance difference and a threshold value. The threshold value is, for example, a value determined based on luminance differences between a plurality of associated image data items used as learning data. Note that the luminance difference between the image data of interest and the reference image data can be calculated based on an average or a dispersion in a certain area. At this time, the luminance difference between the image data items can be calculated, after movement between the image data items is predicted and position alignment is performed. The determination section 902 determines image data, as usable data, from which the luminance difference equal to or smaller than a threshold value is calculated.

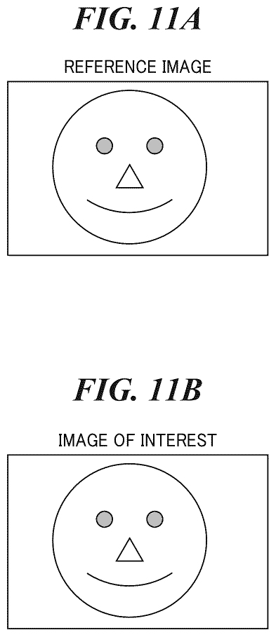

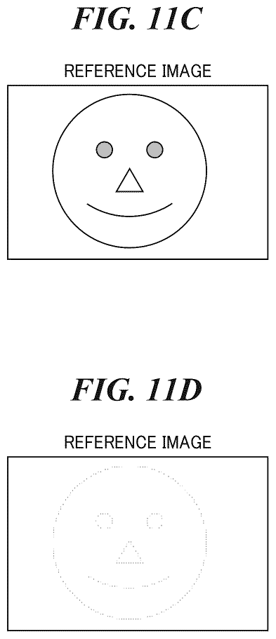

FIGS. 11A to 11D are diagrams each showing an example of image data generated through image capturing. FIG. 11A shows image data of a frame before the image data of interest shown in FIG. 11B. FIG. 11B shows the image data of interest. FIG. 11C shows image data of a frame after the image data of interest shown in FIG. 11B. FIG. 11D shows image data of a frame after the image data of interest shown in FIG. 11B, which is higher in luminance value than the image data shown in FIG. 11C, due to an influence of flash light emission. Note that the image data items shown in FIGS. 11A to 11D are the same in position of the face of the person.

For example, in a case where the image data of interest shown in FIG. 11B and the reference image data shown in FIG. 11A or 11C, of which the luminance difference from the image data of interest is equal to or smaller than the threshold value, are input, it is possible to output image data subjected to the image quality improvement process, from which noise has been eliminated by using the reference image data. Therefore, in a case where reference image data of which the luminance difference from the image data of interest is equal to or smaller than the threshold value is input, the determination section 902 determines that the input image data is usable.

On the other hand, in a case where the image data of interest shown in FIG. 11B and the reference image data shown in FIG. 11D of which the luminance difference from the image data of interest is larger than the threshold value are input, if the image quality improvement process is performed by using the reference image data, identification of noise portions and detection of edges are not properly performed. As a result, it is impossible to output image data subjected to the image quality improvement process, from which noise has been eliminated. For this reason, in a case where reference image data of which the luminance difference from the image data of interest is larger than the threshold value is input, the determination section 902 determines the input image data as unusable.

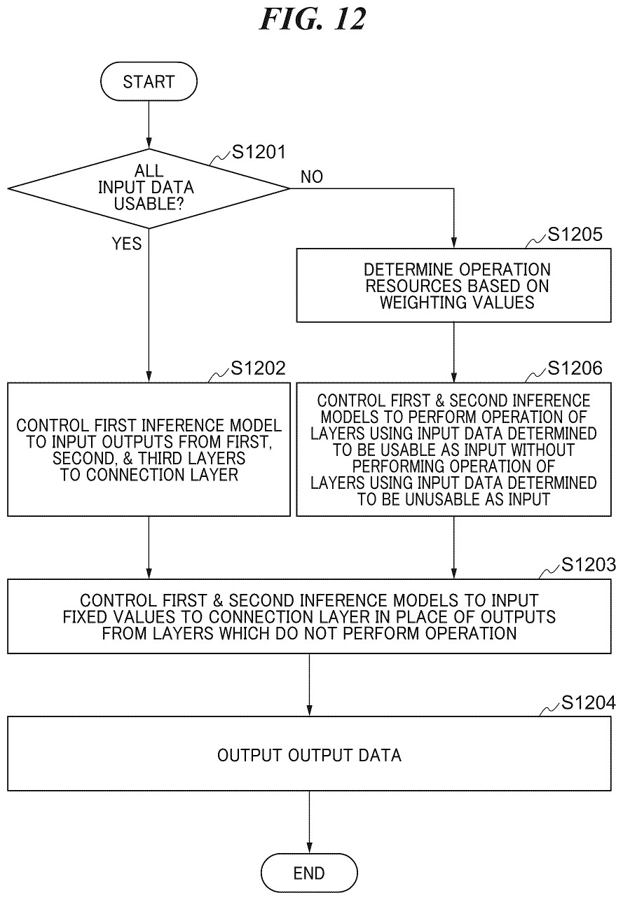

FIG. 12 is a flowchart of the image quality improvement process performed by the control device 900 shown in FIG. 9. The image quality improvement process in FIG. 12 is executed when the control device 900 acquires three image data items obtained through image capturing, as input data.

Referring to FIG. 12, first, in a step S1201, the determination section 902 determines whether or not all of acquired input data items can be used. Specifically, the determination section 902 calculates an evaluation value of each acquired input data item, compares the calculated evaluation value and a predetermined threshold value, and determines whether or not each input data item can be used for inference processing. For example, as described above, the determination section 902 calculates a difference in luminance between the acquired image data of interest and the reference image data and determines whether or not the acquired input data can be used based on a result of comparison between the calculated luminance difference and the threshold value. For example, in a case where the reference image data shown in FIG. 11A, the image data of interest shown in FIG. 11B, and the reference image data shown in FIG. 11C are input as the input data 1, the input data 2, and the input data 3, the respective luminance differences between the reference image data items and the image data of interest are equal to or smaller than the threshold value. In such a case, it is determined in the step S1201 that all of the acquired input data items are usable. In this case, the image quality improvement process proceeds to a step S1202.

In the step S1202, the controller 903 controls the first inference model 1000 to input an output from the first layer 1001, an output from the second layer 1002, and an output from the third layer 1003, to the connection layer 1010. Further, the controller 903 controls the second inference model 1020 such that the fourth layer 1021, the fifth layer 1022, and the sixth layer 1023 do not perform respective operations. Thus, in the present embodiment, in a case where it is determined that all of the acquired input data items are usable, the controller 903 performs the following control: The controller 903 controls the second inference model 1020 such that the second inference model 1020 does not extract feature values, and controls the first inference model 1000 such that the first inference model 1000 outputs the output data from the connection layer 1010 based on a plurality of feature values extracted by the first layer 1001, the second layer 1003, and the third layer 1003.

Then, in a step S1203, the controller 903 controls the first inference model 1000 and the second inference model 1020 such that predetermined fixed values are input to the connection layer 1010 in place of outputs from the layers which do not perform respective operations. Specifically, the controller 903 controls the second inference model 1020 to input the fixed value associated with the fourth layer 1021, the fixed value associated with the fifth layer 1022, and the fixed value associated with the sixth layer 1023 to the connection layer 1010 in place of the outputs from the fourth layer 1021, the fifth layer 1022, and the sixth layer 1023, which do not perform respective operations. Note that the predetermined fixed values are values used when the learning of the first inference model 1000 and the second inference model 1020 was performed.

Then, in a step S1204, the neural network section 901 performs the operation of the neural network according to the control of the controller 903 and outputs image data subjected to the high-quality image processing as the output data. After that, the image quality improvement process is terminated.

On the other hand, for example, in a case where the reference image data shown in FIG. 11A, the image data of interest shown in FIG. 11B, and the reference image data shown in FIG. 11D are input as the input data 1, the input data 2, and the input data 3, the determination is performed as follows: The reference image data shown in FIG. 11D (input data 3) of which the luminance difference from the image data of interest is larger than the threshold value is determined to be unusable. In such a case, it is determined in the step S1201 that one of the acquired input data items is unusable. In this case, the controller 903 weights each acquired image data item based on its luminance difference from the image data of interest. For example, in a case where the luminance differences of the acquired image data items shown in FIGS. 11A, 11B, and 11D from the image data of interest shown in FIG. 11B are 2, 1, 10, respectively, the determination section 902 sets weighting values of 1, 2, and 0 to these image data items, respectively.

Then, in a S1205, the controller 903 determines the operation resources to be used for the fourth layer 1021 and the fifth layer 1022, to each of which data determined to be usable by the determination section 902 is input, based on the set weighting values. For example, in a case where the weighting values set to the image data items shown in FIGS. 11A, 11B, and 11D are 1, 2, and 0 as described above, the controller 903 performs control to divide the operation resources held by the second inference model 1020 at a ratio of 1:2:0. With this control, it is possible to improve the operation accuracy of the fourth layer 1021 by providing more operation resources to the fourth layer 1021 that extracts a feature value from the reference image data. As a result, it is possible to improve the accuracy of an inference result in the image quality improvement process. Note that the operation resources held by the second inference model 1020 can be set to be equivalent to the operation resources held by the first layer 1001 to which the unusable data is input. By doing this, it is possible to suppress lowering of the accuracy of an inference result without changing the amount of the operation resources for performing the inference processing.

Then, in a S1206, the controller 903 controls the first inference model 1000 and the second inference model 1020 such that layers to each of which data determined to be usable is input perform respective operations but layers to each of which data determined to be unusable is input do not perform respective operations. Specifically, the controller 903 controls the first inference model 1000 such that the first layer 1001 and the second layer 1002 to each which data determined to be usable is input perform respective operations, but the third layer 1003 to which data determined to be unusable is input does not perform an operation. Further, the controller 903 controls the second inference model 1020 such that the fourth layer 1021 and the fifth layer 1022 to each of which data determined to be usable is input perform respective operations, but the sixth layer 1023 to which data determined to be unusable is input does not perform an operation. With this control, it is possible to increase the resources to be used for the data determined to be usable by the determination section 902 by an amount of the resources to be used by the second inference model 1020. Further, in the second inference model 1020, information on a human skin area, which is not extracted by the first inference model 1000, is extracted, and hence it is possible to execute filtering processing for suppressing noise reduction (averaging processing) so as to prevent the texture of the human skin from being degraded based on the information. As a result, it is possible to improve the image quality of the image data subjected to the image quality improvement process.

Then, the image quality improvement process proceeds to the step S1203. In the step S1203, the controller 903 controls the first inference model 1000 to input the fixed value associated with the third layer 1003 to the connection layer 1010 in place of an output from the third layer 1003 which does not perform an operation. Further, the controller 903 controls the second inference model 1020 to input the fixed value associated with the sixth layer 1023 in place of an output from the sixth layer 1023 which does not perform an operation. Then, the image quality improvement process proceeds to the step S1204.

In the above-described embodiment, the input data includes image data of interest and reference image data for performing noise reduction for eliminating noise from the image data of interest. With this, in the image quality improvement process, using the image data of interest and the reference image data as inputs, it is possible to suppress lowering of the accuracy of an inference result.

Further, in the above-described embodiment, since the evaluation value is a value related to a difference between the image data of interest and the reference image data, even when improper reference image data having a large difference from the image data of interest is input, it is possible to suppress lowering of the accuracy of an inference result.

Note that in the present embodiment, it is not necessary to match the operation resources used for the second inference model 1020 and the operation resources used for the first layer 1001, and the operation resources are only required to be set to an amount with which it is possible to suppress lowering of the accuracy of an inference result.

Further, in the present embodiment, when the determination section 902 determines whether or not the input data can be used, only one of the three input data items, which is largest in difference between the evaluation value and the threshold value, can be determined to be unusable.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-085463 filed May 24, 2023, which is hereby incorporated by reference herein in its entirety.

What is claimed is:

1. A control device that performs inference processing using a plurality of data items related to each other as inputs, comprising:
a first inference model that is formed by a plurality of layers to which the plurality of data items are input, respectively, for extraction of feature values of input data items, and a connection layer which outputs output data as an inference result based on the extracted feature values;
a second inference model to which any of the plurality of data items are input for extraction of a feature value of each of the any input data item;
a control unit configured to control operations of the first inference model and the second inference model; and
a determination unit configured to determine whether or not each of the plurality of data items is usable for the inference processing,
wherein the control unit controls, in a case where it is determined by the determination unit that all of the plurality of data items are usable for the inference processing, the second inference model not to perform extraction of feature values, and the first inference model to output the output data from the connection layer based on a plurality of feature values extracted by the plurality of layers, and
controls, in a case where it is determined by the determination unit that any of the plurality of data items is unusable for the inference processing, the first inference model to output the output data from the connection layer, based on a feature value extracted by each layer to which data determined by the determination unit to be usable for the inference processing is input, and a feature value extracted by the second inference model using the data determined by the determination unit to be usable for the inference processing as an input.

2. The control device according to claim 1, wherein in a case where it is determined by the determination unit that all of the plurality of data items are usable for the inference processing, the control unit performs control to input a predetermined fixed value to the connection layer in place of an output from the second inference model.

3. The control device according to claim 1, wherein in a case where it is determined by the determination unit that any of the plurality of data items is unusable for the inference processing, the control unit performs control to input a predetermined fixed value to the connection layer in place of an output from a layer to which the data determined by the determination unit to be unusable for the inference processing is input.

4. The control device according to claim 1, wherein the determination unit calculates an evaluation value of each of the plurality of data items, and determines whether or not each data item is usable for the inference processing based on a result of comparison between the calculated evaluation value and a predetermined threshold value.

5. The control device according to claim 4, wherein the plurality of data items are image data and sound data.

6. The control device according to claim 5, wherein the evaluation value is a value related to one of a luminance of each image data item, a blur amount of the image data item, and a high-sensitivity noise amount of the image data item.

7. The control device according to claim 5, wherein the evaluation value is a value related to a noise amount of a feature component of the sound data.

8. The control device according to claim 4, wherein the plurality of data items are a plurality of image data items obtained by capturing an image of a person at different angles.

9. The control device according to claim 8, wherein the evaluation value is a value related to an orientation of a face of a person whose image appears in the image data.

10. The control device according to claim 4, wherein the plurality of data items include image data of interest and reference image data for performing noise reduction for eliminating noise from the image data of interest.

11. The control device according to claim 10, wherein the evaluation value is a value related to a difference between the image data of interest and the reference image data.

12. The control device according to claim 1, wherein the plurality of data items are image data items obtained by capturing an image of an object, and
wherein the determination unit determines whether or not each image data item is usable for the inference processing, based on image-capturing conditions at the time of capturing the image data items.

13. The control device according to claim 1, wherein the plurality of data items are two data items, and
wherein the first inference model includes two layers to which the two data items are input, respectively.

14. The control device according to claim 1, wherein the plurality of data items are three or more data items, and
wherein the first inference model includes three or more layers to which the plurality of data items are input, respectively.

15. The control device according to claim 14, wherein the determination unit calculates evaluation values of the plurality of data items, respectively, and sets weighting values to the plurality of data items based on the calculated evaluation values, respectively, and
wherein in a case where it is determined by the determination unit that any of the plurality of data items is unusable for the inference processing, the control unit determines operation resources of the second inference model based on the weighting values.

16. A method of controlling a control device that performs inference processing using a plurality of data items related to each other as inputs, comprising:
controlling an operation of a first inference model that is formed by a plurality of layers to which the plurality of data items are input, respectively, for extraction of feature values of input data items, and a connection layer which outputs output data as an inference result based on the extracted feature values, and an operation of a second inference model using any of the plurality of data items as an input for extraction of a feature value of the input data item; and
determining whether or not each of the plurality of data items is usable for the inference processing,
said controlling includes:
controlling, in a case where it is determined by said determining that all of the plurality of data items are usable for the inference processing, the second inference model not to perform extraction of feature values, and the first inference model to output the output data from the connection layer based on a plurality of feature values extracted by the plurality of layers, and
controlling, in a case where it is determined by said determining that any of the plurality of data items is unusable for the inference processing, the first inference model to output the output data from the connection layer, based on a feature value extracted by each layer to which data determined by the determination unit to be usable for the inference processing is input, and a feature value extracted by the second inference model using the data determined by said determining to be usable for the inference processing as an input.

17. A learning method of a neural network used for the control device according to claim 1, comprising:
performing first learning using a plurality of learning data items which are a plurality of associated learning data items and are determined by the determination unit to be usable for the inference processing, and the first inference model which operates using the plurality of learning data items as inputs; and
performing second learning using learning data out of a plurality of learning data items related to each other, which is determined by the determination unit to be usable for the inference processing, a second inference model which operates using the learning data determined to be usable for the reference processing as an input, and the first inference model which performs an operation by a layer using the learning data determined to be usable for the reference processing as an input, and operates by inputting an output from the layer and an output from the second reference model to the connection layer.

18. The method according to claim 17, wherein in the first learning, learning is performed by inputting a predetermined fixed value to the connection layer in place of the output from the second inference model.

19. The method according to claim 17, wherein in the second learning, learning is performed by inputting a predetermined fixed value to the connection layer in place of an output from a layer of the plurality of layers, which uses learning data determined by the determination unit to be unusable for the inference processing.

20. A non-transitory computer-readable storage medium storing a program for causing a computer to execute a method of controlling a control device that performs inference processing using a plurality of data items related to each other as inputs,
wherein the method comprises:
controlling an operation of a first inference model that is formed by a plurality of layers to which the plurality of data items are input, respectively, for extraction of feature values of input data items, and a connection layer which outputs output data as an inference result based on the extracted feature values, and an operation of a second inference model using any of the plurality of data items as an input for extraction of a feature value of the input data item;
determining whether or not each of the plurality of data items is usable for the inference processing,
said controlling includes:
controlling, in a case where it is determined by said determining that all of the plurality of data items are usable for the inference processing, the second inference model not to perform extraction of feature values, and the first inference model to output the output data from the connection layer based on a plurality of feature values extracted by the plurality of layers, and
controlling, in a case where it is determined by said determining that any of the plurality of data items is unusable for the inference processing, the first inference model to output the output data from the connection layer, based on a feature value extracted by each layer to which data determined by the determination unit to be usable for the inference processing is input, and a feature value extracted by the second inference model using the data determined by said determining to be usable for the inference processing as an input.
